(19) United States
(12) Patent Application Publication
(10) Pub. No.: US 2010/0140435 A1
(43) Pub. Date: Jun. 10, 2010

(54) Lift System for a Panel and Method for Releasing and Retracing a Panel

(75) Inventor: Franciscus Hendricus Joseph van der Meer, Schoonhoven (NL)

Correspondence Address: SWANSON & BRATSCHUN, L.L.C., 8210 SOUTHPARK TERRACE, LITTLETON, CO, 80120, US

(73) Assignee: LAKE NASSAU B.V., Schoonhoven (NL)

(21) Appl. No.: 12/530,190

(22) PCT Filed: Mar. 7, 2008
(86) PCT No.: PCT/NL2008/050136

§ 371 Date: Oct. 20, 2009

(30) Foreign Application Priority Data
Mar. 7, 2007 (NL) 1033511

(51) Int. Cl. F16M 13/02; A47B 81/06; B66D 1/00

(52) U.S. Cl. 248/324; 254/266

(57) ABSTRACT

A lift system for a panel, provided with a chain, a drive and a housing, wherein the housing is arranged to attach the system to a frame, wall and/or ceiling, wherein, near an end, the chain is arranged to attach a panel, wherein the drive is arranged to retract at least the end of the chain into the housing and to release it from the housing for storing and releasing the panel, respectively, wherein at least a number of successive links of the chain are pivotable relative to one another as far as a stop under the influence of gravity, so that, in use, back parts of the links, of at least a released part of the chain, form an arc.

The invention relates to a lift system for a panel. The invention further relates to a method for releasing and retracting a panel.

Flat screen televisions or other panel-shaped constructions are often used in living rooms, sitting rooms, bedrooms, business accommodations, conference accommodations and/or hotel and catering establishments for showing images and/or information. In most cases, ad hoc measures are taken to support the flat screens. The flat and often heavy flat screens are, for instance, supported by cabinets, shelves or frames. The cabinets are, for instance, provided with wheels so that the cabinets or shelves with the television screens can be wheeled to a particular space to store them there. In this space, the television screens are protected against theft and are not or less in the way. In other cases, for instance, frames with panels, such as image and/or projection screens are permanently attached to the wall.

A drawback is inter glia that such cabinets, shelves or frames take up space usable for other purposes.

At least one of these drawbacks and/or other drawbacks can be obviated with a lift system for a panel according to the invention, provided with a chain, a drive and a housing, wherein the housing is arranged to attach the system to a frame, wall and/or ceiling, wherein the chain is, near an end, arranged to attach a panel, wherein the drive is arranged to retract at least the end of the chain into the housing and to release it from the housing for storing and releasing the panel, respectively, wherein at least a number of successive links of the chain are pivotable relative to one another as far as a stop under the influence of gravity, so that, in use, back parts of the chains, of at least a released part of the chain, form an arc.

The invention enables storing a panel, such as for instance a flat screen, near, against or in a ceiling, wall or frame in a housing. In stored, i.e. retracted position, the panel is largely hidden from view. Here, the panel for instance extends parallel to the ceiling or the wall against which or in which the system is attached. When it is desired that the panel be shown to audience present, the panel is released, rotating and coming down, with the aid of a supporting chain, to a presentation position, in which the screen surface is, for instance, faced towards the audience. During the release, the panel will come down and simultaneously tilt so that it proceeds in an arc from the housing to the presentation position. In this presentation position, back parts, of at least one chain which lowers the panel from the housing, form an arc. Upon again retracting into the housing, the same arc-shaped path will be traversed in a direction back to the housing. The arc-shaped path is inter cilia brought about by the design of the links of the chain. During the release of the chain from the housing, the chain is not in a guide, but comes down outside the housing, clear of any guide. Any guide of the chain is located in the housing.

In one embodiment, the coming down of the panel will largely be able to take place with the aid of the gravity of the panel and/or the chain, while, for retracting, for instance a cable can be used in a relatively simple manner, so that the chain and the panel can be retracted into a housing again. In the released position, the chain assumes an arc shape under the influence of gravity, the arc shape being determined by the design of the links. In the arc shape, successively links pivot relative to one another as far as a stop, also referred to as back-flexing, so that, via back parts of the chains, an arc-shaped force transmission may take place. For instance, the weight of the panel is transmitted to, for instance, the housing via the arc shape of the links.

The space taken up by the panel in the presentation position becomes available again upon retracting the panel. Then, the system may, for instance, be attached against or in the ceiling and/or high up against or in a wall so that it is largely hidden from view and/or outside a part of the space to be used. Then the panel is also protected from theft without a second space in the building being needed for this.

At least one of above-mentioned drawbacks and/or other drawbacks may also be obviated with a method for releasing and retracting a panel from and into a housing, respectively, wherein a panel is attached near the end of a chain, wherein the panel and at least a part of the chain are released, wherein at least a number of successive links of the released part of the chain pivot relative to one another as far as a stop under the influence of gravity, so that back parts of the respective links form an arc.

Further advantages and characteristics of the present invention follow from the following description, in which the invention is described in more detail in multiple exemplary embodiments with reference to the appended drawings, in which:

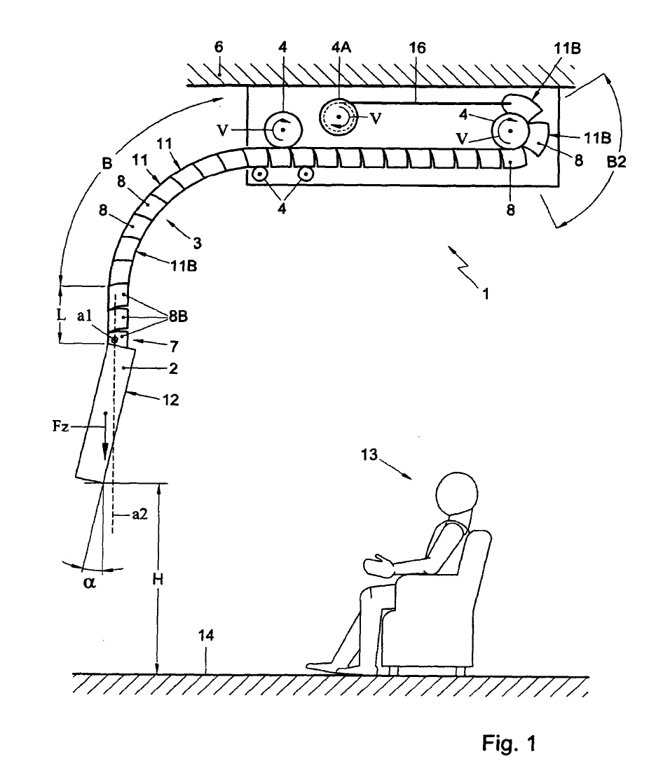

FIG. 1 schematically shows, in side elevational view, a lift system according to the invention;

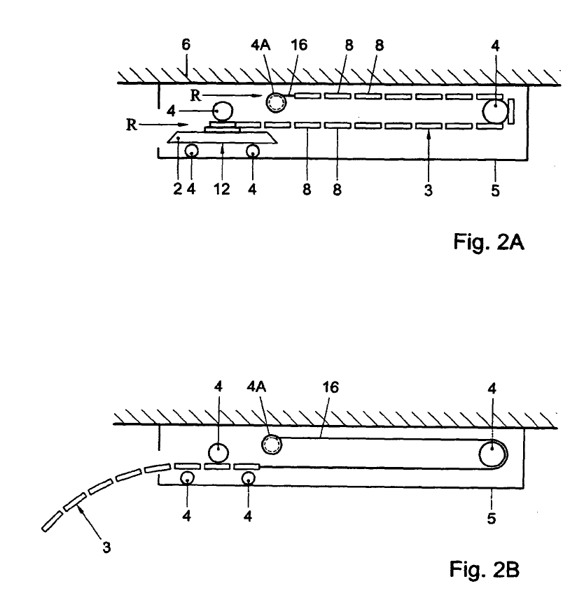

FIG. 2A schematically shows, in side elevational view, a lift system according to the invention;

FIG. 2B schematically shows, in side elevational view, a lift system according to the invention;

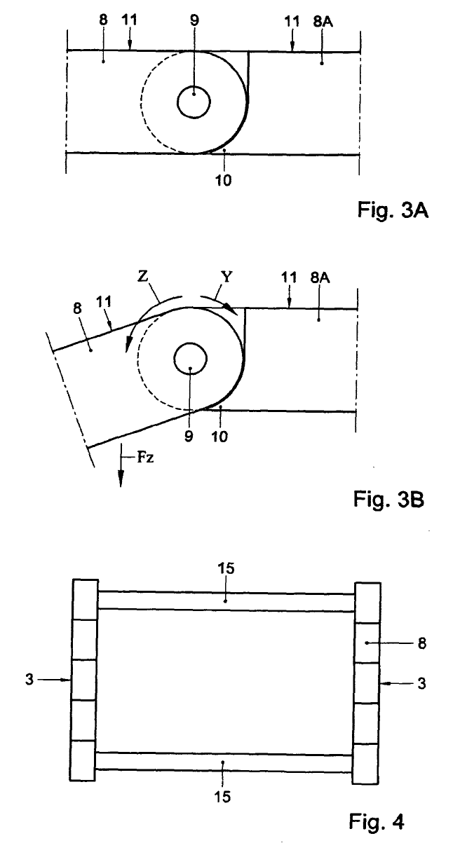

FIGS. 3A and 3B schematically show, in side elevational view, parts of linked links according to the invention;

FIG. 4 schematically shows, in front view, a part of a lift system according to the invention;

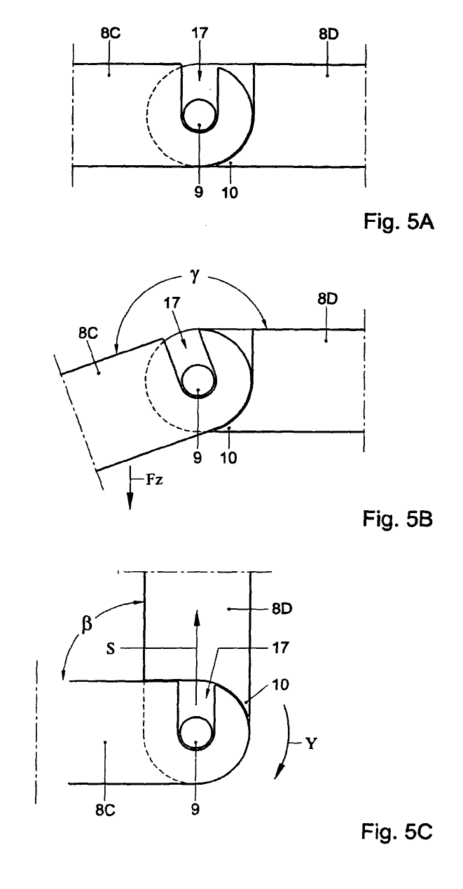

FIGS. 5A, B and C schematically show, in side elevational view, parts of linked links according to the invention;

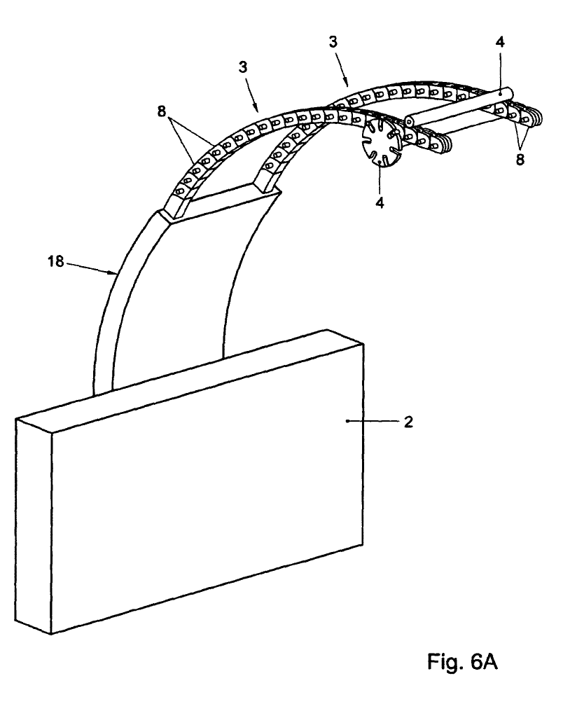

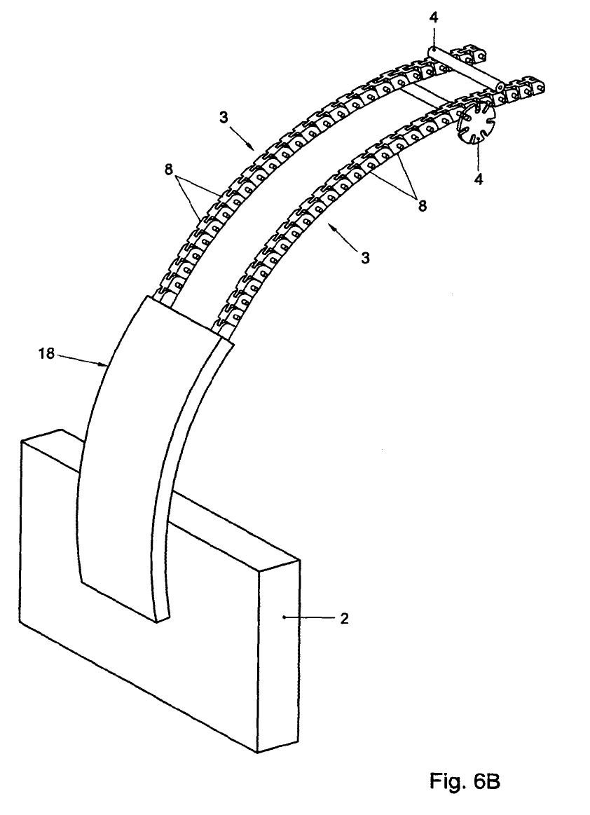

FIGS. 6A and 6B show, in perspective views rotated with respect to each other, parts of a lift system according to the invention;

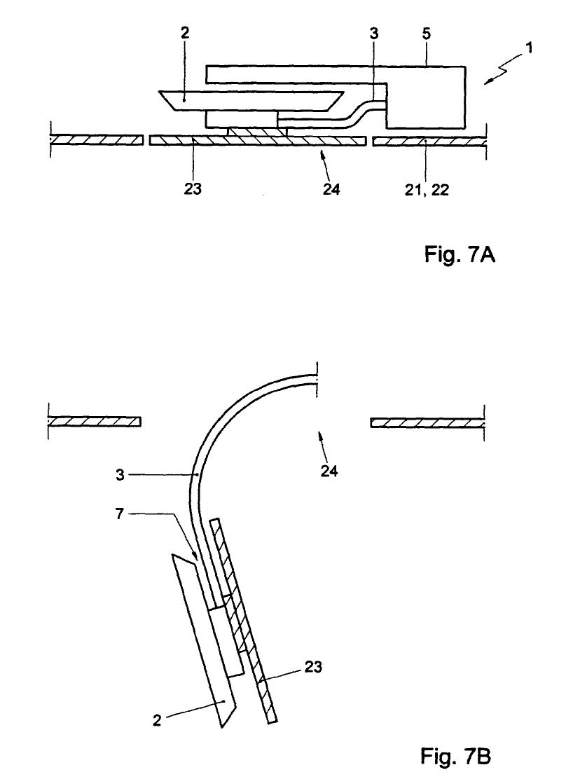

FIGS. 7A and 7B schematically show, in side elevational view, a lift system according to the invention;

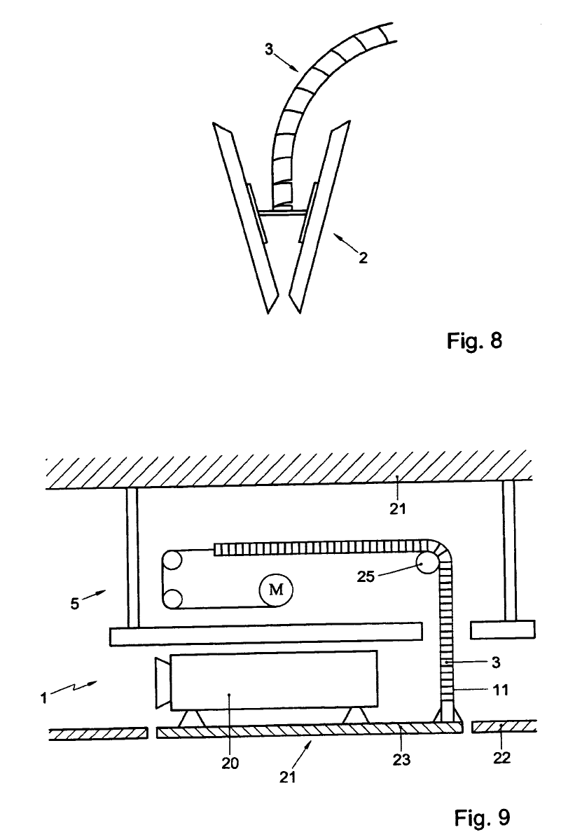

FIG. 8 schematically shows, in side elevational view, a part of a lift system according to the invention;

FIG. 9 schematically shows, in side elevational view, a lift system according to the invention;

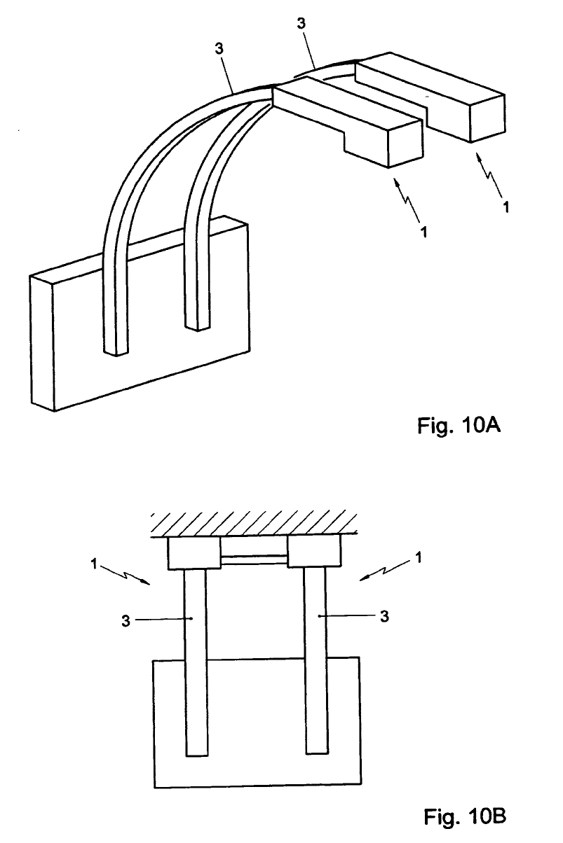

FIGS. 10A and 10B show a schematic perspective view and a schematic rear view of a lift system according to the invention; and

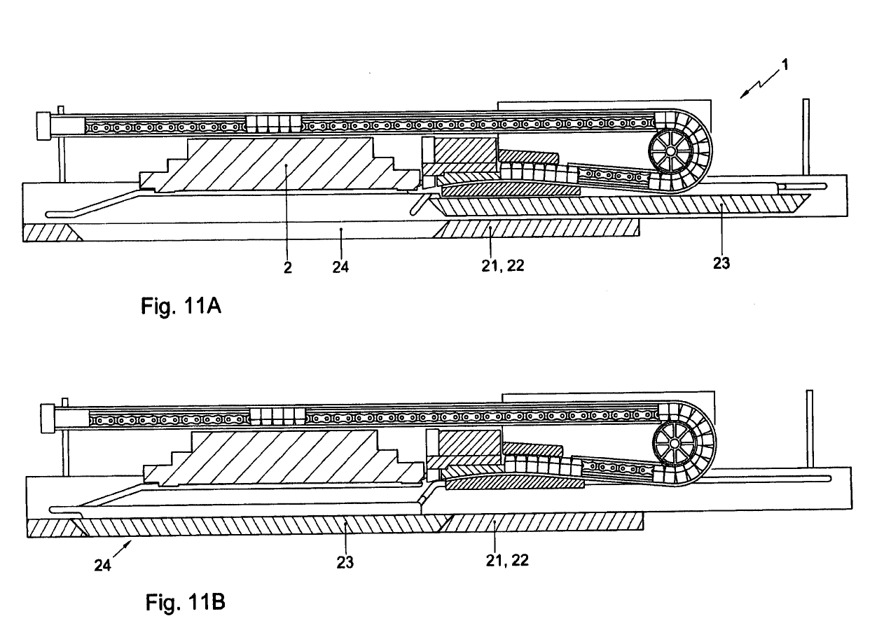

FIGS. 11A and 11B schematically show a side elevational view of a lift system according to the invention.

In this description, same or corresponding parts are designated by same or corresponding reference numerals. In the drawing, embodiments are only shown by way of example. The elements used therein are only mentioned as an example and should not be taken as being limitative in any way. Other parts may also be used within the framework of the present invention. The proportions of the embodiments shown in the Figures are mostly shown schematically and/or exaggeratedly and should not be taken as being limitative in any way.

FIG. 1 schematically shows a side elevational view of an embodiment of a lift system 1. The lift system 1 shown comprises a panel 2, a chain 3, a drive and a housing 5. The housing 5 is attached to a ceiling 6. The lift system 1 is shown in a released condition, where the panel 2 and a part of the chain 3 located outside the housing 5 are released. In the released condition, the part of the chain 3 located outside the housing 5 is clear of any guide. Optionally, the chain 3 may run in or along a guide in the housing 5, here for instance along rolls 4. In a retracted condition, preferably the whole panel 2 and the whole chain 3 are received in the housing 5, as schematically shown in FIG. 2A.

The chain 3 supports the panel 2 from the housing 5. As can be seen in FIG. 1, the panel 2 is attached near an end 7 of the chain 3. The drive enables the chain 3 to be released from the housing 5 and to be retracted therein again. Instead of one, in principle, multiple virtually parallel chains 3 may be used, as for instance shown in FIGS. 6A, 6B, WA, 10B, where two chains are used to, for instance, release an extra heavy and/or large panel from a housing and retract it into a housing. This is inter alia favorable to be able to absorb the possibly high load of the panel 2 and/or parts connected therewith. Here, for instance, multiple chains 3 may be provided separately from one another, optionally connected by cross connections. In a further embodiment, for instance, multiple chains 3 are attached to one another per link and/or per hinging element 9, one or more strings of multiple chains 3 thus being provided per string.

In the embodiment shown, the drive comprises inter cilia drive rolls 4, 4A. At least one drive roll 4A is, for instance, driven by a rotation motor or another drive means. This drive roll 4A may, for instance, also drive other rolls 4, at least, upon release of the panel 2, provide at least an initial drive of the other rolls 4, so that the panel 2 is guided out of the housing even before the gravity of the panel 2 and/or the chain 3 pull the chain 3. Incidentally, for instance, a spring mechanism may also provide this initial drive.

The chain 3, at least during retraction, is driven by the drive roll 4A and guided along the rolls 4. Here, the drive roll 4A pulls the chain 3 and enables the chain 3 and the panel 2 to be retracted along the rolls 4 into the housing 5. Upon release, the rolls 4A and/or 4 rotate, for instance, in a direction V (see FIG. 1) so that the chain 3 and the panel 2 are pushed out of the housing. To this end, the chain 3 has the properties of a push chain.

Incidentally, in particular embodiments, it is also possible that the drive, for instance, comprises gear wheels in addition to and/or instead of the rolls 4, 4A. Multiple forms of drive can be used to drive and release the chain 3.

If the panel 2 is located outside the housing 5, the gravity Fz of the panel 2 and possibly the gravity of at least a part of the chain 3 pull the chain 3 so that the chain 3 will bend downwards along an arc B. The pushing property of the chain 3 causes the arc B to extend away from the housing 5 upon release of chain 3 and panel 2. Here, also due to above-mentioned gravity Fz, the chain is subjected to tensile loads and, as a result, also has the properties of a chain 3 for tensile loads.

In one embodiment, the transmission to the chain 3 from the drive roll 4A takes place by means of a pull cable 16, which pull cable 16 is attached between the chain 3 and the drive roll 4A. Upon rotating of the drive roll 4A in the rotating direction V, for instance, the pull cable 16 is released and the gravity Fz pulls the chain 3 and pull cable 16. Here, it is possible that a second drive roll 4 will drivingly rotate in a direction V to drive and release the chain 3. As a result, the chain 3 and/or the panel 2 is is released from the housing 5. If the drive roll 4A rotates in a direction opposite above-mentioned direction V, the cable 16 can be wound along the drive roll 4A in an advantageous manner, for instance in that the drive roll 4A is arranged to guide the cable 16 during winding up. The cable 16 can extend between the end 7 of the chain 3 and the drive roll 4A, for instance the cable 16 may run through the back parts of the links 8 of the chain 3. Also, the cable may extend between an end of the chain 3 located opposite end 7 of the chain 3 and the drive roll 4A, such as for instance shown in FIG. 2B, where, in this case, the cable 16 virtually does not run through the links of chain.

With rotating of the drive roll 4A in opposite direction, the pull cable 16 is wound around the drive roll 4A, so that the cable 16 takes up little space, while at least a part of the chain 3 is retracted into the housing and stored. For instance, the pull cable 16 is manufactured from a suitable plastic, for instance plastic fiber-reinforced material such as Dyneema®. Dyneema® is suitable for relatively high tensile loads, at which it will show virtually no stretch. In addition, the material is relatively flexible and therefore suitable for winding up around a roll. Thus, it is both strong and easy to coil up. In other embodiments, the pull cable 16 may, for instance, be manufactured from at least one metal, for instance from steel.

FIG. 2B shows that the pull cable 16 can extend to relatively far from the drive roll 4A upon release of the chain 3 from the housing 5. With a stationary drive, the strength and/or stiffness of the pull cable 16 causes at least drive roll 4A, the chain 3 and the panel 2 to be stopped in a stable manner.

In one embodiment, the chain 3, at least back parts 11 of links 8 of this chain, has/have a virtually smooth and/or toothless design so that they are also guided along rolls 4 having a relatively smooth design. Here, the transmission takes place by means of the pull cable 16 and/or by the gravity Fz.

The arc B is determined by the design of the links 8 of the chain 3. One embodiment of links 8 is shown in FIGS. 3A and 3B, where successive chains 8, 8A are, in principle, shaped the same. As can be seen, the links 8 are linked by means of hinge parts 9 and provided with a stop 10.

In a released condition, such as in FIG. 1, the gravity Fz contributes to the released links 8, i.e. at least the links 8 located outside the housing 5, having the tendency to pivot about a hinge part 9 in a pivoting direction Z, as far as a stop 10 of a second link 8A connected to this first link 8 on the side of the housing 5. An unpivoted and pivoted position of the first link 8 relative to the second link 8A connected thereto are shown in a somewhat exaggerated manner in FIGS. 3A and 3B, respectively. Of course, the second link 8A, if released, is in turn pivoted relative to a third link 8 connected thereto on the side of the housing 5. In other words, substantially all links 8, 8A are in principle shaped and linked in the same manner. Due to the successive pivoting movements, back parts 11 of successive links 8 of at least the released part of the chain 3 will form an arc B, as can be seen in FIG. 1, while the chain 3 will extend away from the housing 5 and downwards. The pivoting of the links 8 as far as a stop 10 is also referred to as back-flexing. In the exemplary embodiment of FIG. 1, back-flexing of the chain occurs on the inside of the arc. Here, the inside of the arc is formed by the back parts 11B.

As described hereinabove, in one embodiment, the coming down of the panel 2 will largely be able to take place with the aid of the gravity Fz of the panel 2 and/or chain 3 while, for retracting, for instance a cable 16 can be used in a relatively simple manner, so that the chain 3 and the panel 2 can be retracted into a housing 5 again. Here, in an advantageous manner, the chain 3 may be designed to be relatively smooth on the outside and be guided along relatively smooth rolls 4.

If the chain 3 is relatively far released, it may be the case that some links 8B extend in a virtually vertical direction since they will no longer pivot in a direction Z under the influence of the gravity Fz. The back parts 11 of these links 8B will no longer form an arc B but a substantially straight line L. Thus, a height H of the panel 2 to the ground 14 can be set in an advantageous manner by releasing or retracting the chain 3, for instance such that a projection surface 12 of the panel 2 is at a comfortable height for an audience 13. Depending on the length of the released part of the chain 3, not only the height H but also the angle α can be set. That is to say, in one embodiment, especially in the initial stage of release of the panel 2, when the end 7 of the chain 3 forms at least a part of the arc B, the panel 2 will tilt and both the angle α and the height H of the panel are partly determined by the length of the released part of chain 3.

It is advantageous if the links 8 can pivot sufficiently freely in a second direction Y, away from the stop 10, to form a short arc B2, for instance to be coiled around a roll 4. The arc B2 then formed by second back parts 11B of the links 8 has a radius which is considerably smaller than the radius of the arc B of the released back parts 11. This also allows the chain 3, for instance as can be seen in FIG. 2A, to be received in the housing 5 in multiple rows R and a relatively long chain 3 to completely fit into a relatively small housing 5. In particular embodiments, it is for instance possible to coil up the chain 3 on a roll 4 inside the housing 5.

At the end of the chain 3, the panel will be freely suspended from the chain 3, i.e. without fixed hinge point, while it is settable for height and/or angle with the aid of the chain 3. Here, with the chain 3, it can be brought about in an advantageous manner that the required force for absorbing the gravity Fz is largely absorbed by successive second back parts 11B (see FIG. 1) on the inside of the chain 3, at the location of the arc B.

In one embodiment, the chain 3 and the panel 2 are completely received in the housing 5. Thus, they are hidden from view and the attention of the audience can be better focused on other things. In addition, the panel 2 is thus better protected against theft. The housing 5 may also have a second function, for instance as a support of lighting or the like. A housing 5 which at least largely surrounds the contents is, for instance, advantageous because the contents can be kept dust-free for long periods. In addition, the chain 3 and/or the panel 2 will not pollute the environment upon release. This is, for instance, favorable for the mechanical and/or electronic parts which may be present in the housing 5 and/or for instance lubricant for the chain 3. In addition to these things, the housing 5 may also contain the usual electronics and/or for instance a receiver for a remote control controlling the lift system 1.

Because the housing 5 is attached to the ceiling 6, the system 1 takes up virtually no space to be used. Incidentally, the housing 5 may also be placed against a wall, or indirectly on a wall or ceiling 6, via a frame or the like. The housing 5 may also be attached in a ceiling or wall.

For operating the lift system 1, in one embodiment, a remote control is provided. Functions which the remote control may at least have are, for instance, retracting and releasing the chain 3 and the panel 2, but the panel 2 itself may, for instance, be operated as well, with a sort of integrated remote control for a television or computer. The operation of the panel 2 may then, for instance, involve setting the spatial orientation of the panel 2, so that, with the remote control, the panel 2 can tilt and the angle α and height H can be set.

In one embodiment, the chain 3 is therefore provided with a rotating mechanism which sets the angle α of the panel 2 with respect to the end 7 of the chain 3. Here, the panel 2 rotates about a first axis a1, approximately parallel to the projection surface 12 and the ground 14. As can be seen, this axis a1 is perpendicular to the plane of FIG. 1. The angle α of the panel 2 can then be set in a favorable manner, for instance so that the projection surface 12 is directed to the audience 13 in a comfortable manner, without the height H of the panel 2 being adjusted. In a particular embodiment, the rotating mechanism is arranged such that the panel 2 also and/or only rotates about a second axis a2, shown in FIG. 1 by a dotted line. This, for instance, allows the projection surface to turn to the sides. These axes a1, a2 may of course also assume other and/or multiple orientations. Multiple embodiments of rotating mechanisms for bringing about one or multiple axes of rotation for the panel 2 are suitable. For instance, the rotating mechanism is attached to a last link 8 of the chain 3, i.e. the link 8 which is, in released condition, removed furthest from the housing 5, between the last link 8 and the panel 2. Another embodiment uses, for instance, two approximately parallel chains 3, where the chains can be driven, for instance retracted and/or released, separately, so that the angle setting of the panel 2 changes. Also, multiple chains 3 may be provided with separate control elements for electrically and/or mechanically controlling the panel 2. Here, for instance for multiple angle settings of the panel 2, two approximately parallel chain strings may also be used.

In or near the housing 5, for instance a computer and/or feeder cable may be located which are to control the panel. Particularly when the panel 2 comprises such electrotechnology, for instance in the case of a television and/or computer screen, it is advantageous if these cables are guided along the chain 3 to the panel 2 for being connected to the panel 2. In use, the respective cable is preferably already connected to the panel 2 before release of the panel 2. For instance, the panel 2 is automatically switched on in a particular released condition, i.e. presentation position, of the panel 2. Here, for instance, the remote control may control the images on the panel 2 optionally via electronics present in the housing 5 or for instance directly via the panel 2. It is, for instance, advantageous when, for guiding the computer and/or feeder cable, a cable duct is provided in, along and/or near the chain 3 which can guide and/or protect one or more of these cables. In one embodiment, the cables are, for instance, guided through the links 8. With multiple chains 3, of course also multiple (supply and/or computer) cables can be guided. Further, for instance, per chain 3, cables can be guided, for instance of the same construction as the pull cable 16, which cables can set the orientation of the panel in a mechanical manner.

In one embodiment, two or more parallel chains 3 are provided which support the panel 2, see FIG. 4. This is, for instance, advantageous to prevent torsion in the chains 3 and/or delays the possible wear of the chain 3 and/or contributes to increased stability. In addition, then extra tensile load can be absorbed. In a further embodiment, for instance, cross connections 15 are provided, for instance for extra prevention of torsion and/or for keeping the chains 3 virtually parallel and/or also contributing to increased stability. The cross connections 15 may, in addition, serve as support for an above-mentioned cable duct.

The lift system 1 and in particular the chains 3 are preferably arranged to resist high loads. To this end, in one embodiment, solid links 8 are used, for instance manufactured from hard and/or strong materials such as fiber-reinforced plastic or metal.

In particular embodiments, the links 8 are provided with separate hinge parts 9, for instance separate hinge pins. In still other embodiments, the links are provided with integrated hinge parts 9. Separate hinge parts 9 are, for instance, favorable to the freedom of construction and/or the strength and/or stiffness of the links 8. In particular, with the use of hard material, for instance separate hinge parts 9 may be preferred.

With integrated hinge parts 9, the chains 3, at least the links 8, may be assembled, i.e. mounted, efficiently, for instance by snapping and/or sliding links 8 into one another and/or due to the absence of separate parts to be assembled. With integrated hinge parts 9, dust can be prevented from coming between the hinge parts 9 and the links 8. Integrated hinge parts 9 may, in addition, contribute to the outside of the chain 3 being relatively smooth.

One embodiment with which assembly can take place efficiently and where also a relatively strong and stiff chain 3 can be achieved comprises, for instance, links 8 with integrated hinge parts 9, 17 as shown in FIGS. 5A-5C.

In FIG. 5A, two, in essentially identical, linked links 8C, 8D extend horizontally. A simple mounting position is shown in FIG. 5C, where the links 8C and 8D can relatively simply be slid apart, while FIGS. 5A and 5B show positions of use, where the hinges do not slide apart. In FIG. 5A, the first link 8C, without stop 10, engages, for instance by means of a second hinge part 17, in the embodiment shown in the form of an opening, around integrated hinge part 9 of the second link 8D with stop 10. As can be seen, the stop 10 blocks the hinge parts 9, 17 from being able to slide apart. As can be seen in FIG. 5B, the first link 8C pivots, in a released position, due to the gravity Fz, in a direction Z around the hinge part 9 as far as the stop 10. The angle γ between the links 8C, 8D is for instance about 185° in this position. In both FIGS. 5A and 5B, the positions of the links 8C, 8D are mutually such that they cannot be slid apart, in particular due to blocking by stop 10. FIGS. 5A and 5B thus shown blocking positions of the successive links 8C, 8D. FIG. 5C show a mounting position of the links 8C, 8D, where the stop 10 releases the second link 8D to be slid out of the first link 8C. Here, the integrated hinge part 9 can be slid out of the second hinge part 17 in that the first link 8C is sufficiently rotated with respect to the second link 8D in a second direction Y, opposite to the first direction Z. The sliding angle β between the links 8C, 8D in the mounting position (FIG. 5C) is, for instance, about 90° and thus differs about 95° from the angle γ between the links 8C, 8D in the stopped position of FIG. 5B. With an angle between the links 8C, 8D of, for instance, about 135°, the stop 10 still blocks, for instance, which is also intended since the chain 3 also needs to be coiled up, for instance around a roll 4, while the first link 8C is also rotated with respect to the second link 8D in the second direction Y. The number of degrees of the sliding angle β should not be chosen too large, for instance between about 30° and 135°, in order to still be able to coil up the chain 4 in an advantageous manner, at least to allow it to form a second arc B2. Multiple manners are suitable to bring about a mounting position and/or sliding angle β in a favorable manner for linking links 8C, 8D with integrated hinge parts 9, 17, and therefore there should be no limitation to the hinge parts 9, 17, links 8C, 8D and/or sliding angles β mentioned above and/or shown.

An advantage of links 8 slidable into one another is generally that relatively stiff and/or strong links 8 can be used without extra separate parts needing to be assembled, such as for instance separate hinge pins. With any ‘snapping’ into one another of links 8, a drawback could be that the material needs to be somewhat flexible at the snap connection, at the expense of, for instance, the stiffness. For instance, the hinge parts 9, 17 may, for instance, have a partly flexible/elastic design, while they precisely need to absorb large forces. Thus, such snap connections would possibly make the links 8 unsuitable for the high safety, stiffness and/or strength requirements imposed on the links 8, at least the chain 3. It is therefore advantageous if successive links 8 have a mounting position, such as for instance shown in FIGS. 5A-C, where the links are pivoted relative to one another away from the stop 10 so that the hinge parts 9, 17 of the links can be slid apart. When they are pivoted more towards the stop 10, for instance if a gravity Fz is exerted in a released position, the links 8 are in a blocking position (see for instance FIG. 5A or 5B), in which they are blocked from being able to slide apart, for instance by the stop 10. Thus, the large forces are, for instance, absorbed by the stop 10 and/or the hinge part 9 and/or 17 which are sufficiently stiff and/or strong for the high load requirements on the chain 3 and, also, this prevents separate parts from having to be used for assembling the links 8. Incidentally, it is also possible to dimension the links 8 such that, in addition to being able to slide into one another, they are also can also be snapped into one another somewhat, for instance when, for extra safety, during the sliding of the links 8 into one another, the first hinge part 9 is pushed, i.e. ‘snapped’ through the second hinge part 17. Here, the links 8 are prevented from simply, for instance in certain positions automatically, sliding apart. It is also possible that, with an embodiment with these mounting positions, still, additional separate parts are used in assembly of the chain 3. Having a mounting position and/or blocking position for mounting the chain 3 may be advantageous, but should not be limited to the embodiments as, for instance, shown in FIGS. 5A-5C.

In one embodiment, the chain 3 is equipped with a safety system which prevents pivoting of released links 8 in a direction away from the stop 10 when the panel 2 has been released, i.e. is in the presentation position. This prevents anyone from knocking/pushing against or pulling the panel 2, with the panel 2 tilting and then pivoting back.

FIGS. 6A and 6B show parts of an embodiment of a lift system 1 according to the invention, in which the front and back side of the system 1 are shown, respectively. Here, the housing 5 is omitted. The links 8 connect relatively closely to one another. In an advantageous manner, two chains 3 are used. A coupling element 18 is present between the chain 3 and the panel 2. This coupling element 18 prevents, for instance, fingers from being able to get just above the panel 2 near the links 8. Further, this coupling element 18 can serve as a type of lid which closes off an opening of the housing 5 upon retracting of the chain 3 into the housing 5. The coupling element 18 may, for instance, advantageously be equipped to attach the panel 2 thereto and/or suspend it therefrom, and/or to attach above-mentioned rotating mechanism to. In addition, in coupling element 18, for instance, connections for the panel 2 may be provided and/or the coupling element 18 can contribute to a better guidance in the housing 5.

According to the invention, panel 2 may, in principle, comprise any type of panel 2, for instance a flat screen, an LCD/TFT screen, any type of computer or television screen, a projection screen on which, for instance, projection can take place with an audio/video projector or other projector, a panel with an image and/or other panels 2. Thus, for instance, in FIG. 9, a lift system 1 is shown for a projector 20. In FIG. 9, the lift system 1 is mounted in a space between a ceiling 21 and false ceiling 22. In retracted position, thus, the projector 20 can be stored virtually completely in the ceiling and be hidden from view. Upon changing, the projector 20 will be lowered substantially in virtually vertical direction. The design of the links of the chain 3 is such that, upon release, a part of the chain 3 will come down in virtually vertical direction approximately straight downwards. In this exemplary embodiment, in the straight part of the chain 3, back-flexing of the links 8 occurs on the back side of the chain 3, which is formed by the back parts 11 of the links 8. In order to largely hide the projector 20 from view in retracted position, the lift system 1 is provided with a cover plate 23 which virtually completely closes off the opening 24 through which the projector 20 passes upon release and/or retraction. When only a limited overall height is available, the cover plate 23 may also be slid along the ceiling 22 or 21, as is, for instance, shown in FIGS. 11A and 11B. In FIG. 11A, the cover plate 23 is shown in slid-away position, with the opening 24 being free to allow a panel 2 through. In FIG. 11B, the cover plate 23 is shown in closed position, with the opening 24 being closed off. In this closed position of the cover plate 23, the lift system 1 virtually completely hidden from view and concealed in the ceiling 21 or 22. The lift system 1 may be provided in a false ceiling 22 or may also be provided in a recess in a ceiling 21.

Optionally, the cover plate 23 may also be provided on the back of the panel 2, as shown in FIG. 7. The visible side of the panel 2 is then, in the released position, facing another side than shown in, for instance, FIG. 1. In retracted position, shown in FIG. 7A, the cover plate 23 then virtually completely covers the opening 24. The lift system 1 with panel 2 may thus disappear into the ceiling 22 or 21 so as to be virtually completely be hidden from view. The ceiling 21 or 22 can thus maintain a virtually smooth appearance in the retracted position of the lift system 1.

In released position, shown in FIG. 7B, the panel 2 and the cover plate 23 have come down and the chain 3 at least partly forms an arc. With a drive, the screen panel 2 can thus be moved into and/or from the ceiling 21, 22 and, upon retracting of the panel 2, the opening 24 in the ceiling 21 or 22 can be closed off. When the cable 16 extends through the back parts of the links 8 between the end 7 of the chain 3 and the drive roll 4A, in released condition, a force can be transmitted via the links 8 of the chain 3 by back-flexing of the links 8, and via the cable 16. By dividing the force between the chain 3 and the cable 16, the arc shape of the chain 3 remains intact when the panel 2 comes down further. Optionally, the force on the cable 16 may be set, for instance via the drive roll, to thus set an angle of inclination of the panel 2. Thus, for instance, an optimal viewing angle and/or viewing height may be set.

The lift system 1 according to the invention may, for instance, but not exclusively, be used for and/or within transport facilities such as buses or airplanes, the hotel and catering industry, hotel rooms, conference or other business accommodations, in rooms in houses, such as living, sitting or bedrooms, recreation rooms, for cinemas, etc. Depending on the space within which the lift system 1 is place, the dimensions of the lift system 1 and/or the panel 2 may differ. Thus, for instance, in FIG. 8, an exemplary embodiment is shown where a panel 2 is designed as two screen panels which are attached at the end of the chain 3 with their back sides towards each other. This may, for instance, be favorable for large public spaces.

It is noted that there is to be no limitation to the embodiments shown and/or described. For instance, the chain 3, links 8 and/or the drive may be specified in various manners. In particular, the links 8 and/or the stops 10 may be designed in various manners, where the design may differ considerably from what has been shown and/or described, while still the working principle of the invention is satisfied.

The variations described and many similar variations, as well as combinations thereof, are considered to fall within the framework of the invention set forth in the claims. Of course, different aspects of different embodiments and/or combinations thereof may be combined and exchanged with one another within the framework of the invention. Thus, there is to be no limitation to only the embodiments mentioned and/or shown.

1. A lift system for a panel comprising:
a chain having a distal end arranged to attach a panel;
a drive operatively associated with the chain;
a housing being configured to attach the system to a frame, wall and/or ceiling;
the drive being constructed and arranged to retract at least the distal end of the chain into the housing and to release it from the housing for storing and releasing a panel attached to the chain, respectively; and
at least a number of successive links of the chain being pivotable relative to one another as far as a stop under the influence of gravity, so that, in use, back parts of the links, of at least a released part of the chain, form an arc.

2. The lift system of claim 1 further comprising the housing being configured to at least partly surrounds the panel.

3. The lift system of claim 1 further comprising the links being pivotable in a direction away from the stop so that the chain can be coiled up.

4. The lift system of claim 1 further comprising near the distal end, the chain is provided with a rotating mechanism for setting the angle of a panel.

5. The lift system of claim 1 further comprising a cable duct operatively associated with the chain, which extends parallel to the chain.

6. The lift system of claim 1 further comprising a connection cable extending along or in the chain, the connection cable comprising a feeder cable and/or signal-transmitting cable for connecting to a flat screen.

7. The lift system of claim 1 further comprising the links being provided with integrated hinge parts.

8. The lift system of claim 1 further comprising-two successive links configured to provide a mounting position and a blocking position, the links in the mounting position, being capable of pivoting relative to one another, away from the stop, so that the hinge parts of the successive links can be slid apart, and the links in the blocking position being blocked from being able to slide apart.

9. The lift system for a panel of claim 1 wherein the drive comprises a plastic fiber cord which can be coiled up, the plastic fiber cord being connected with the chain as a pull cable.

10. The lift system of claim 1 further comprising the chain being equipped with a facility for tilting an attached panel in two directions.

11. The lift system of claim 1 further comprising the chain having a safety system to prevent pivoting of the links away from the stop.

12. The lift system of claim 1, wherein at least two parallel chains are provided.

13. The lift system of claim 12 further comprising cross connections between the chains.

14. The lift system of claim 13, further comprising a duct connected with the cross connections.

15. The lift system of claim 1 wherein an outer surface of the links is virtually smooth.

16. The lift system of claim 1, further comprising the housing being provided with rolls for coiling up and/or guiding the chain.

17. The lift system of claim 16, wherein the rolls are toothless rolls.

18. The lift system of claim 1, further comprising a remote control configured to remotely actuate the drive.

19. The lift system of claim 1, further comprising a panel attached to the chain near the distal end.

20. (canceled)

21. The method for releasing and retracting a panel from and into a housing, respectively, wherein a panel is attached near a distal end of a chain, wherein the panel and at least a part of the chain are released, wherein at least a number of successive links of the released part of the chain pivot relative to one another as far as a stop under the influence of gravity so that back parts of the respective links form an arc.

22. The method of claim 21, wherein the angle and the height of the panel are determined by the length of the released part of the chain.
